(19) United States
(12) Patent Application Publication
(10) Pub. No.: US 2026/0359204 A1
(43) Pub. Date: Nov. 12, 2026

(54) SYSTEMS AND METHODS FOR SOFTWARE TESTING

(71) Applicant: The PNC Financial Services Group, Inc., Pittsburgh, PA (US)

(72) Inventor: Jon S. Rutkauskas, Pittsburgh, PA (US)

(73) Assignee: The PNC Financial Services Group, Inc., Pittsburgh, PA (US)

(21) Appl. No.: 19/467,072

(22) Filed: Feb. 2, 2026

Related U.S. Application Data
(63) Continuation of application No. 19/348,461, filed on Oct. 2, 2025.
(60) Provisional application No. 63/801,641, filed on May 7, 2025.

(51) Int. Cl. G06F 11/3668

(52) U.S. Cl. CPC G06F 11/3688

(57) ABSTRACT

Systems and methods are provided for software testing. In some embodiments, the system may receive a parameter configured to affect the execution of a software element. According to some embodiments, if the parameter contains a numerical value corresponding to a period of time, the system may pause execution of the software element for a duration corresponding to the period of time. According to some embodiments, the system may send a notification to a user device associated with the software element advising that the software element is paused for the duration. According to some embodiments, the system may permit resumption of execution of the software element following the duration. According to some embodiments, the system may send a notification to the user device advising that execution of the software element has resumed following the duration.

### CROSS-RFERENCE TO RELATED APPLICATIONS

This application is based on and claims benefit of priority of U.S. Provisional Application No. 63/801,641, filed May. 7, 2025, the entire contents of which are incorporated by reference.

### TECHNICAL FIELD

The present disclosure relates generally to systems and methods for software testing. More particularly, the disclosure is directed to the use of a software testing tool that receives one or more parameters for affecting the execution of a software element, including pausing, crashing, or otherwise modifying the behaviour of the element during operation.

### BACKGROUND

Testing modern software applications presents numerous challenges, particularly in environments where concurrent execution or timing-sensitive operations may affect program behavior. Developers often attempt to evaluate how an application will respond to unusual or unexpected conditions, such as delays, interruptions, or crashes. Traditional testing techniques may be limited in their ability to reproduce these conditions consistently, as many problems arise only when operations are executed at precise intervals or when multiple software processes overlap in unpredictable ways.

For example, in some cases, an application may encounter a race condition or an ordering effect when two processes execute in rapid succession. In other cases, a developer may wish to test whether a system can recover from a pause of a defined period of time, or from a forced crash operation. Without a dedicated testing tool, reproducing such behaviors often requires manual trial-and-error, which can be burdensome, error-prone, and difficult to repeat. In many cases, developers attempting to reproduce these scenarios manually may misjudge the exact timing of an operation, overlook the order in which the software elements interact, or fail to apply the same sequence of steps across repeated tests. Such inconsistencies may result in conflicting outcomes, wasted effort, and incomplete data about the behavior of the application under test. The risk of human error therefore compounds the difficulty of reproducing timing-sensitive failures, underscoring the value of a tool that enforces consistency and reduces reliance on manual intervention.

Existing testing approaches may also lack the ability to provide clear notifications or outputs regarding the state of the software under test. Logs may be incomplete, inconsistently formatted, or unavailable in real time, leaving developers unable to confirm whether inserted conditions were executed as intended. Moreover, as applications are increasingly deployed in distributed systems and dynamic environments, traditional testing methods may fail to provide the reliability and precision required to validate critical functionality.

Accordingly, there is a need for improved systems and methods for software testing that allow a developer or tester to supply parameters directing a software element to pause, crash, or otherwise alter its execution characteristics. By enabling deterministic control of such behaviors and providing corresponding outputs to a user device, the disclosed systems and methods address shortcomings of prior testing approaches and support more reliable validation of software performance

### SUMMARY

Systems and methods are provided for software testing. According to some embodiments, a system, method, or computer readable medium may be configured to execute stored instructions to perform steps associated with the systems and methods. In some embodiments, the system may receive a parameter configured to affect the execution of a software element. According to some embodiments, the system may receive a parameter configured to affect the execution of a software element in a controlled and repeatable manner. The parameter may take a variety of forms, including but not limited to numerical values, strings, or null values, and may be used to modify execution flow in ways that allow testers to observe resulting behaviour.

In some embodiments, if the parameter contains a numerical value corresponding to a period of time, the system may pause execution of the software element for a duration corresponding to the period of time. The pause may allow testers to observe whether the software element continues to function as expected following the delay or whether timing-related errors occur. According to some embodiments, the system may further send a notification to a user device associated with the software element advising that the software element is paused for the duration. According to some embodiments, the system may permit resumption of execution of the software element following the duration. According to some embodiments, the system may send a notification to the user device that the pause remained in effect for the specified duration and advising that execution of the software element has resumed.

In some embodiments, the system may receive a parameter configured to affect the execution of a software element. According to some embodiments, if the parameter contains an instruction associated with the software element, the system may crash execution of the software element. According to some embodiments, the system may then send a notification to a user device associated with the software element advising that the software element crashed.

### BRIEF DESCRIPTION OF THE DRAWINGS

The accompanying drawings, which are incorporated in and constitute a part of this specification, illustrate disclosed embodiments and, together with the description, serve to explain the disclosed embodiments.

FIG. 1 illustrates an exemplary desire for testing concurrent functioning of software, consistent with disclosed embodiments.

FIG. 2 illustrates an exemplary desire for testing system execution failure outcomes, consistent with disclosed embodiments.

FIG. 3 illustrates an exemplary system for software testing, consistent with disclosed embodiments.

FIG. 4 illustrates an exemplary process for software concurrency testing, consistent with disclosed embodiments.

FIG. 5 illustrates an exemplary process for software failure testing, consistent with disclosed embodiments.

FIG. 6 illustrates an exemplary system overview showing components of a software testing tool and their interaction with a processor, computer readable medium, software elements, parameter input, and user device, consistent with disclosed embodiments.

FIG. 7 illustrates an exemplary flowchart of a method for software testing, consistent with disclosed embodiments.

### DETAILED DESCRIPTION

Reference will now be made in detail to exemplary embodiments, discussed with reference to the accompanying drawings. Unless otherwise stated, technical and/or scientific terms have the meaning commonly understood by one of ordinary skill in the art. It is to be understood that other embodiments may be implemented and that changes may be made without departing from the scope of the disclosed embodiments. For example, unless otherwise indicated, method steps disclosed in the figures may be rearranged, combined, or divided without departing from the envisioned embodiments. Similarly, additional steps may be added, or steps may be removed, without departing from the envisioned embodiments. Thus, the materials, methods, and examples are illustrative only and are not intended to be necessarily limited.

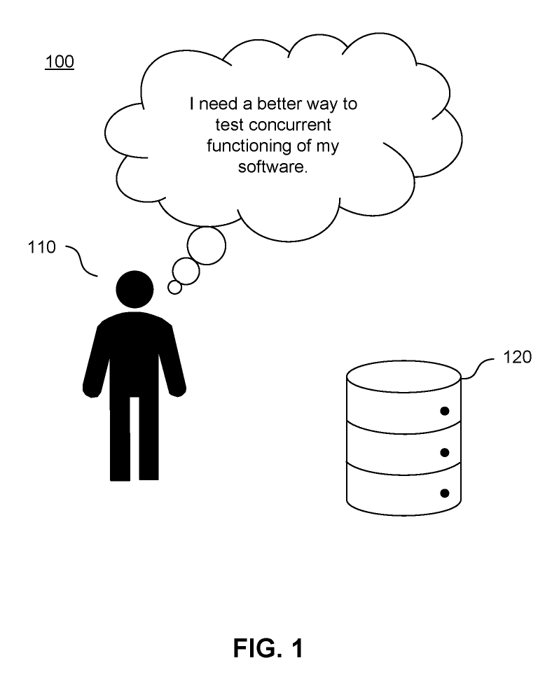

Turning to FIG. 1, a scenario 100 is illustrated in which a developer 110 encounters challenges associated with concurrent software execution. In particular FIG. 1 shows a developer or tester, such as developer 110 shown in scenario 100, who may desire to determine whether a given piece of software, such as software stored on server 120, operates as expected across a range of scenarios. In some cases, software is tested that is configured to run at the same time as (or concurrently with) other software. Said developer 110, may interact with one or more software elements to evaluate the execution characteristics of those elements. In some cases, use of the software in a given order or under given conditions may lead to unexpected outcomes from execution of the software. In some cases, testers, such as developer 110, may desire to test the outcome of more than one software process executing a given piece of software at the same time. In some cases, user performance of steps out of an expected order or performance of steps unexpectedly quickly may lead to race conditions, in which software executes in an unexpected order, which may lead to unexpected outcomes. Said unexpected outcomes may include ordering effects or duplicate operations that do not occur when software elements are executed individually. As such, system developers and testers, such as developer 110, may desire to run the software reliant on different orders and conditions.

Executing software based on certain orders and conditions in a deployed testing environment, however, may be unduly burdensome or infeasible. Testing certain operating conditions, especially operating conditions for user interactions, may require a human tester, such as developer 110, to rapidly perform operations leading to software execution. In some instances, software may execute within milliseconds, leading testers desiring to test edge cases within the execution window to perform operations within milliseconds. Such rapid operation execution may be impossible to test. So, certain software operating conditions may go untested, either by choice or due to practical impossibility. Yet, such software operating conditions may be statistically likely to occur after deployment of the software, such as when multiple users desire to execute the same software at the same time. If tested, the testing procedure may require repeated software execution by a tester or group of testers, which may require inordinate use of developer time and resources, leading to undue expenses for a system developer.

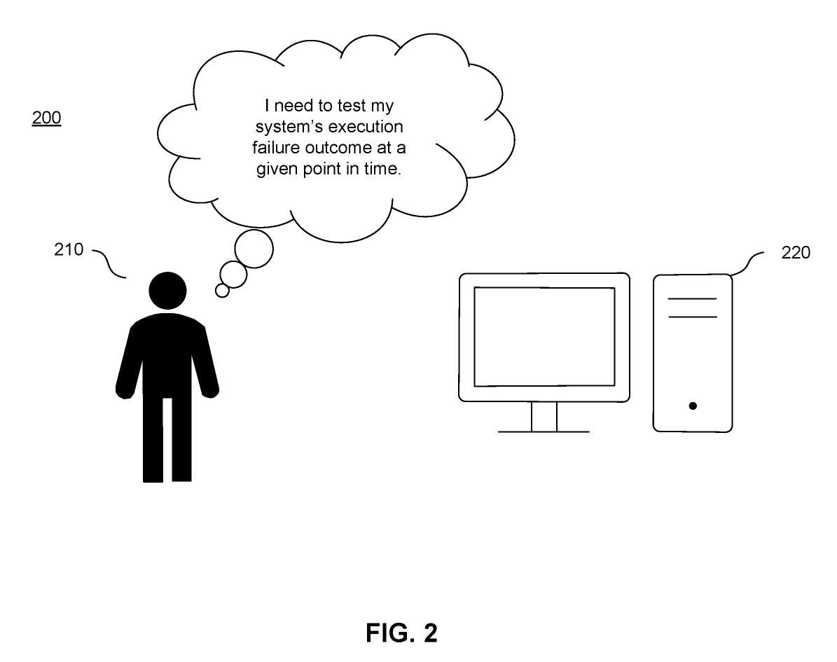

Turning to FIG. 2, system developers and testers, such as developer 210 shown in system 200, may desire to determine the execution failure outcomes of a system 200, such as operation 220, consistent with disclosed embodiments. Testing execution failure may allow testers, such as developer 210, to determine whether the system handles errors appropriately and/or may allow testers to ensure that, after failure of a request, subsequent requests can process successfully, including whether error messages are generated and whether subsequent requests can continue to execute successfully after the failure has occurred. In many cases, however, testing such recoverability may be cumbersome, and may involve disabling an application, eliciting failures or manually changing code associated with an application to intentionally cause system failure. Each recoverability testing procedure may require system downtime (including downtime for systems not being tested), rebuilding, restarting applications, and cooperation with developers across systems and applications.

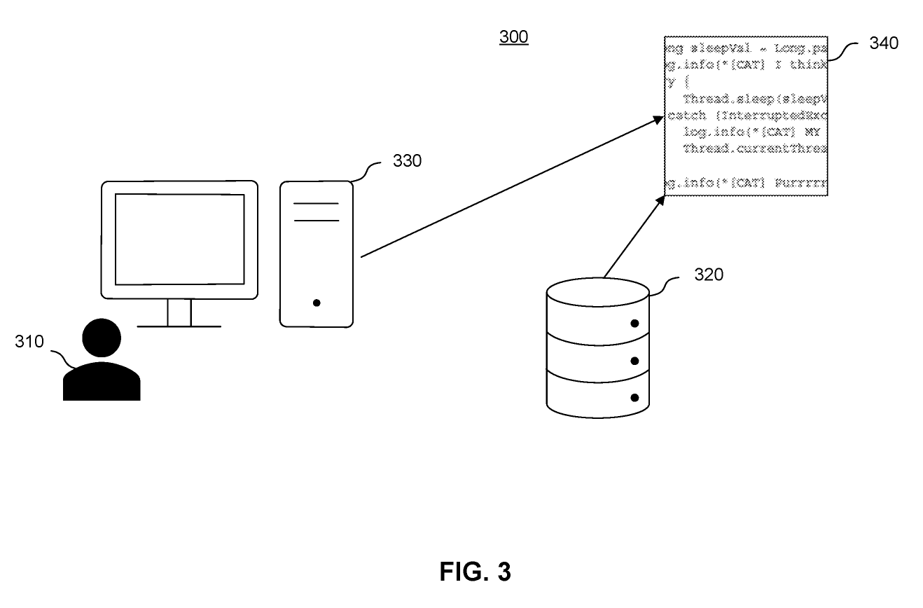

Turning to FIG. 3, what is needed is a software testing tool, such as software testing tool 340 shown in system 300, consistent with disclosed embodiments. The tool may contain a suite of software testing features directed to improving a software tester’s, such as developer 310’s, ability to test rapid code execution, for example, of code stored on server 320. The tool may further contain a suite of software testing features directed to improving a software tester’s, such as developer 310’s, ability to test a system’s, such as operation 330’s, ability to recover from a request failure, execution failure, or system failure. In some embodiments, the software testing tool 340 may be embodied in a computer readable medium storing instructions executable by one or more processors. The processors may access memory resources to carry out operations, including applying parameters that direct the behavior of software elements under test. In some embodiments, the software testing tool may be temporarily integrated with software code and may allow testers, such as developer 310, to set per-request sleep timers and crash points for software testing purposes.

In some embodiments, the software testing tool 340 may be an application written in a programming language such as Java, C, C++, Python, JavaScript, Rust, or the like. The mention of various programming languages is intended to demonstrate that the software testing tool 340 may be implemented in complied or interpreted environments and is not limited to any specific platform. In some embodiments, the software testing tool 340 may be integrated into a software application or into source code for application testing. The integration of the software testing tool 340 may be permanent or temporary. In instances in which the integration is temporary, the software testing tool 340 and any mention of the software testing tool 340 may be removed from the software application or source code after testing.

In some embodiments, use of the disclosed software testing tool 340 may require the presence of a compatible software environment. For example, the application under test may be implemented using a programming framework, a runtime environment, or a supported library. In certain cases, the application may also provide an interface such as an application programming interface, through which the software testing tool 340 may interact with the application. In other cases, the software testing tool 340 may be an application testing tool and may interact with the code of the application itself and later be removed once testing is complete. Because the software testing tool 340 requires only limited conditions to operate, it may be easily adopted in a variety of modern application environments without requiring significant modification of the underlying application.

In some embodiments, the software testing tool 340 may include parameters that are not actively invoked during execution of the software under test. The presence of such unused parameters does not alter or interfere with the normal operations of the software. Instead, these parameters may remain dormant until they are invoked, or may simply be ignored by the application, if they are not used. This allows developers to place the parameters at multiple points in the application code without concern that the uninvoked parameters will negatively affect the execution, thereby simplifying integration of the software testing tool 340 into the application.

The software testing tool 340 may include at least one public class configured to impact the operation of a system being tested. In some embodiments, the public class may be called by the software to be tested. The call of the public class may include at least one parameter value, such as a numerical value corresponding to a period of time, a string corresponding to a crash instruction, or a null value to trigger an execution error. Such a parameter may direct the function performed by the software testing tool 340, such as pausing software operation or crashing, as described herein. The software testing tool 340 may further be configured to result in command line outputs and/or log file outputs to facilitate use of the software testing tool and to allow a tester to confirm that the requested parameter was executed as intended.

The disclosed software testing tool 340 may be inserted directly into an application or its source code either on a temporary basis for testing analysis or on a permanent basis for development. This flexibility allows the software testing tool 340 to be used across different programming languages and environments without requiring major permanent changes to the application.

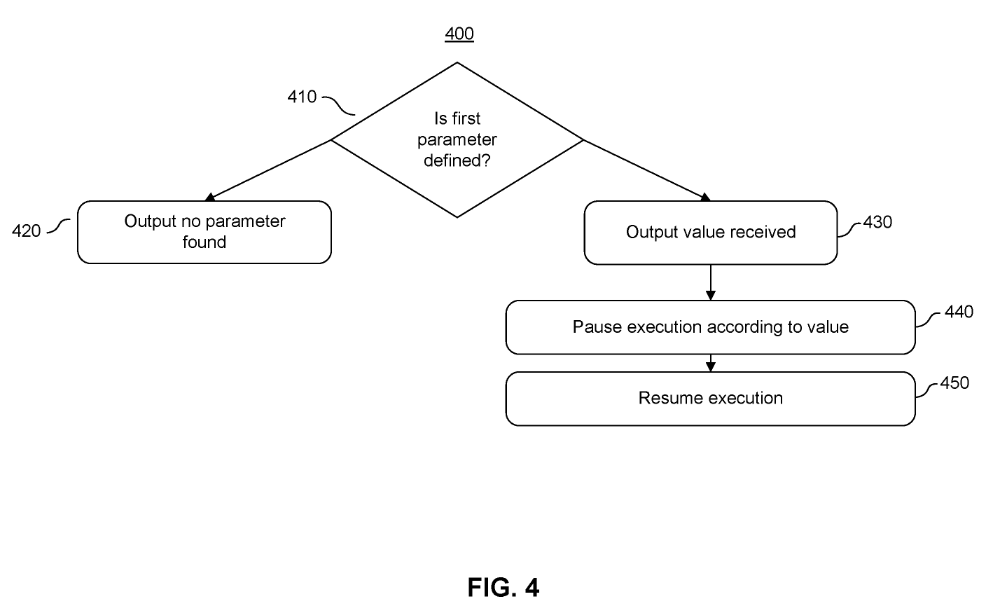

Turning to FIG. 4, process 400 is disclosed. In some embodiments, the software testing tool may be configured to check for a given parameter at step 410 of process 400. In some embodiments, the software testing tool may be configured to output to a log or command line a message indicating that the software testing tool is checking for the given parameter. At step 420, if the check indicates that no value has been set for the given parameter, the software testing tool may output to a log or command line a message indicating that no parameter was found. At step 430, if the check indicates that a value has been set for the given parameter, the software testing tool may output to a log or command line a message indicating receipt of the value and may store or reference the parameter for subsequent operations, such as initiating a pause or crash sequence.

In some embodiments, the value for the given parameter may be a numerical value representing a period of time that the software being tested should sleep or pause software execution. The value may be given in units, such as a number of milliseconds or seconds, that the software being tested should be paused, thereby defining the duration of the pause. The pause may be in the form of a thread sleep instruction directed to the thread executing the software being tested, which may include the value indicating the length of time the thread should sleep. As such, at step 440, the software being tested may pause according to the value. In some embodiments, the software testing tool may output to a log or command line a message indicating that the software being tested is sleeping for a period of time corresponding to the value.

In some embodiments, a sleep interrupt signal routine may be included. In some embodiments, the sleep interrupt routine may be implemented in the form of catching an interrupt exception and interrupting the thread. In some embodiments, the sleep interrupt routine may be accompanied by a message to a log or command line indicating that the sleep was interrupted. At step 450, in some embodiments, following the period of time corresponding to the value, the software testing tool may be configured to permit resumption of operation of the software being tested, or operation of the software being tested may resume automatically following the period of time corresponding to the value. In some embodiments, following the period of time corresponding to the value, the software testing tool may output to a log or command line a message indicating that the period of sleep corresponding to the value has concluded.

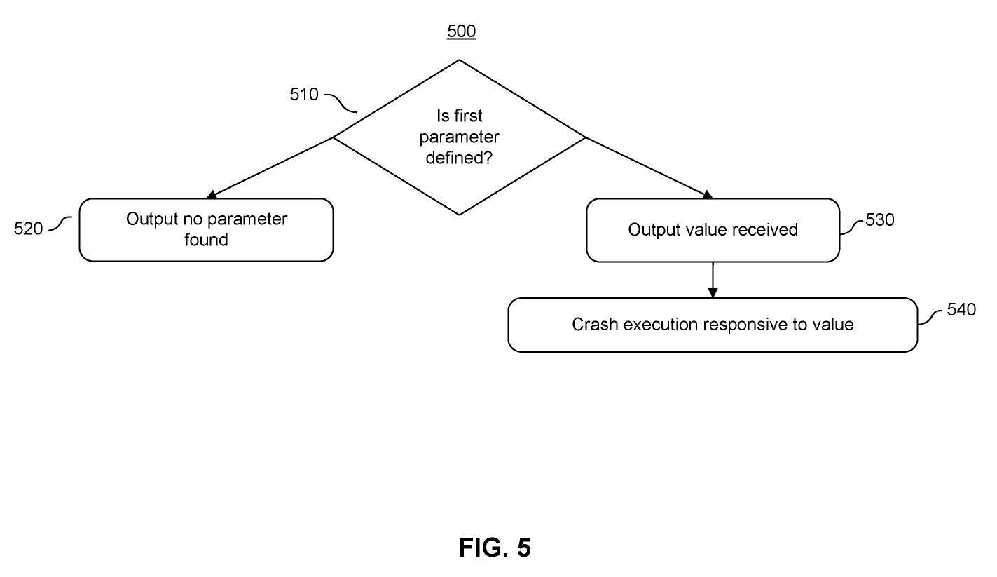

Turning to FIG. 5, process 500 is disclosed. In some embodiments, the software testing tool may be configured to check for a given parameter at step 510 of process 500. In some embodiments, the software testing tool may be configured to output to a log or command line a message indicating that the software testing tool is checking for the given parameter. At step 520, if the check indicates that no value has been set for the given parameter, the software testing tool may output to a log or command line a message indicating that no parameter was found. At step 530, if the check indicates that a value has been set for the given parameter, the software testing tool may output to a log or command line a message indicating receipt of the value and may store or interpret the parameter as a command corresponding to a crash instruction.

In some embodiments, the value for the given parameter may be a request that the software being tested crash at a given point in execution of the software. The parameter may be expressed as a string value, such as “CRASH”, or as another indicator associated with a user-defined location in the code. At step 540, the software being tested may crash in response to the value. A software crash operation may cause the software to stop execution and may lead the software to be unable to continue execution from the location of the crash.

In some embodiments, the software crash may be accompanied by a message to a log or command line indicating that the software being tested has crashed. In some embodiments, the message may include an indication that the crash was intended. In some embodiments, the software crash may be accompanied by a thrown exception. The thrown exception may invoke expected response behavior in the software being tested, in response to a crash, thereby allowing evaluation of the software’s behavior in handling an execution error or other failure condition.

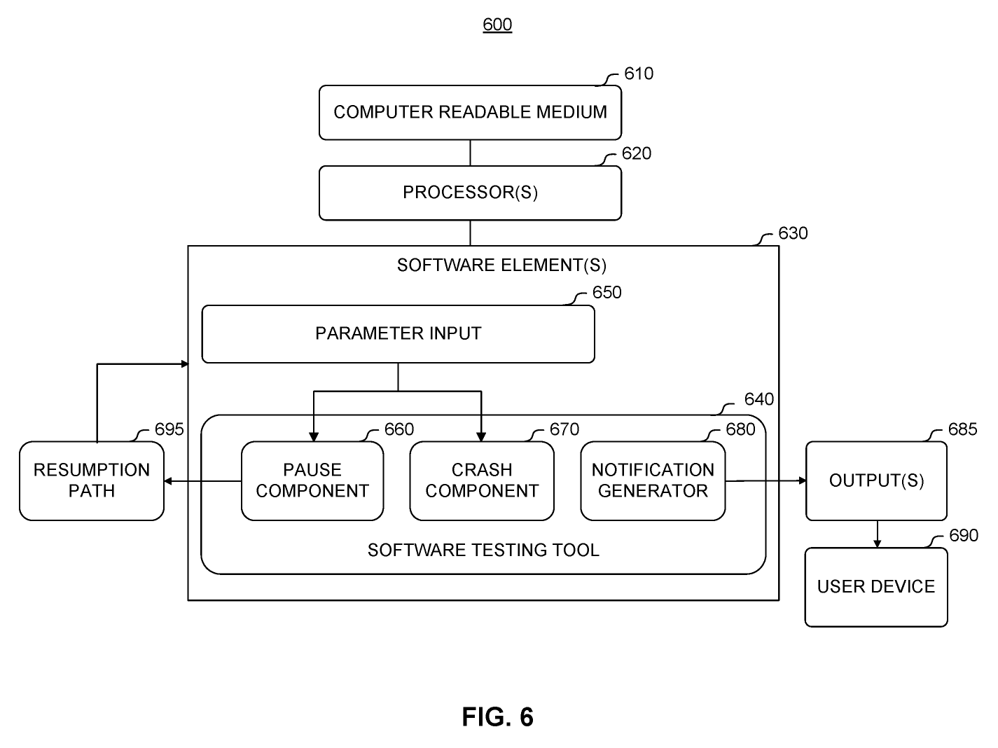

Turning to FIG. 6, an exemplary system overview 600 is illustrated, showing components of a software testing tool and their interaction with a processor, computer readable medium, software elements, parameter input, and a user device, consistent with disclosed embodiments. Although depicted as discrete blocks, the components of system 600 may be combined, subdivided, or distributed across hardware and software layers without departing from the scope of the present disclosure. In some embodiments, the system 600 includes a computer readable medium 610 configured to store instructions that, when executed by one or more processors 620, cause the processors to perform operations associated with software testing. The computer readable medium 610 may include transitory or non-transitory storage, such as random-access memory (RAM), read-only memory (ROM), flash memory, optical or magnetic storage, or cloud-based storage. The processors 620 may include single-core or multi-core processors, physical or virtualized instances, or distributed processing elements in a cloud computing environment.

The system 600 may include a parameter input 650, which represents an interface for receiving one or more parameters that affect the execution of a target software element 630. The parameter input 650 may accept a numerical value corresponding to a period of time, a string value corresponding to a crash command, or a null value that may trigger an execution error. The parameter input 650 may be provided through a variety of inputs, including a command-line argument, an environment variable, a configuration file, or a request-level input, such as a query string.

Responsive to a parameter indicating a duration, the system may invoke a pause component 660 configured to suspend execution of the software element 630 for the specified period of time. The pause component 660 may implement a thread sleep instruction or similar mechanism, thereby halting a thread executing the software element. The pause may last for a defined interval, which may be specified in units of milliseconds, seconds, clock cycles, or other measures of time. In some embodiments, the pause component 660 may detect an interrupt signal during the pause and terminate the suspension in response.

Responsive to a parameter indicating a crash, the system may invoke a crash component 670 configured to intentionally halt execution of the software element 630. In some embodiments, the crash component 670 may throw an exception, terminate a process, or invoke another crash routine. A crash may occur at a user-defined location within the software element 630, permitting controlled testing of recoverability. In some embodiments, the crash component 670 may further be configured to simulate different classes of execution failure, including request-level errors, service-level interruptions, or system-wide halts.

The system 600 may include a notification generator 680 that produces one or more outputs 685, indicating the state of execution. The outputs 685 may include command-line notifications, entries in a log file, or messages transmitted to a monitoring service. Notifications may indicate that a parameter was received, that a pause has been initiated, that a sleep period was interrupted, that execution has resumed, or that a crash has occurred.

A resumption path 695 may be provided to allow the software element 630 to continue execution following the completion of a pause or after a crash has been handled. In some embodiments, the resumption path 695 may represent an execution flow that allows subsequent requests or processes to proceed without requiring a redeployment or restart of the application.

The system may further communicate with a user device 690 associated with a tester or developer. Outputs 685 may be transmitted to the user device 690 to advise the tester of the current state of execution and facilitate real-time interaction with the testing process. Collectively, the above components may be embodied in a software testing tool 640 that is temporarily embedded in a software element 630 for the duration of testing. The software testing tool 640 may be removed from the source code or application prior to deployment in a production environment.

In some embodiments, the software testing tool may be configured to generate visualizations of testing results for presentation on a user device. The visualizations may provide a graphical interface that enables a developer to observe the execution of software elements subject to testing. For example, the tool may present a view showing when a parameter was invoked, when a pause was initiated, when an interruption was detected, or when a crash occurred. Such a display may allow testers to confirm the precise sequence of events and to identify concurrency conditions that would otherwise be difficult to discern from text logs alone.

In some embodiments, the visualization may include a process flow diagram or execution tree illustrating how different parameter values affect the execution of software elements. A graphical user interface may highlight certain sections corresponding to paused states, crashed states, or resumed execution, along with associated data such as timestamps, thread identifiers, or parameter values. In further embodiments, the interface may allow zooming, filtering, or searching across recorded outputs, enabling testers to focus on particular execution paths or error conditions.

In some embodiments, the software testing tool may support a dashboard that combines multiple visualization elements. For example, a dashboard may include a chart of active threads, a table of logged parameter values, and a notification panel displaying recent crash or pause events. Such dashboards may also integrate with external monitoring or compliance systems, allowing developers to correlate testing results with system metrics such as utilization, memory consumption, or network traffic.

In some embodiments, the software testing tool may be integrated into an application as a standalone module or as a component of a distributed system. For example, in a microservice environment, the tool may be incorporated into one, two, or all of the services that form part of an application under test. Each integration may be independent, allowing developers to validate the behavior of one service without modifying others. In other embodiments, the tool may be packaged as a plugin that can be attached to different environments without altering the underlying system architecture.

In further embodiments, the software testing tool may be deployed in connection with a version control system or a continuous integration/continuous deployment (CI/CD) pipeline. In such cases, developer modifications to source code may include temporary insertion of calls to the software testing tool. Once testing is complete, control operations such as reversion, reset, or removal may be used to eliminate the testing code. By leveraging version control, developers may ensure that the integration of the testing tool is temporary, repeatable, and reversible.

In further embodiments, CI/CD pipelines may be configured to automatically incorporate the testing tool into an environment. For example, when source code is submitted to a version control system, the CI/CD pipeline may compile the code, inserting the testing tool into the application, and deploy the build into a controlled test environment. The pipeline may also be configured to remove the testing tool from subsequent production builds, thereby ensuring that the tool is present only while testing.

These integration features may allow developers to use the software testing tool without incurring long-term architectural changes. By automating insertion and removal of the tool, the system supports efficient, repeatable testing across different environments while preventing the persistence of testing code in the system.

In some embodiments, the software testing tool may be deployed in a dynamic or real-time environment, such as a live application server. Because the tool is integrated into the application under test, the tool may behave deterministically even as the environment changes. For example, if a dependency service becomes slower, a network delay occurs, or a background workload shifts, the tool may still provide consistent outputs, allowing testers to observe whether the behavior of the application under test has changed under new operating conditions.

In some embodiments, the software testing tool may be configured to simulate time-sensitive behavior by introducing controlled delays into execution. For instance, a parameter may be specified to delay execution of a workload for a defined period of time, such as 10 seconds, thereby simulating a slower dependency. The tool may then allow testers to evaluate whether the application under test continues to meet its requirements despite the altered timing. By adjusting parameters to introduce such delays, testers may observe system behavior in real time, including whether dependent systems can tolerate increased runtimes or whether the application experiences failures such as missed deadlines, overflows, or errors.

In further embodiments, the tool may be employed to reproduce changes consistently across multiple test runs. These conditions may be introduced through parameters rather than occurring randomly, so that developers can repeat tests to confirm that observed behaviors are attributable to the environment rather than coincidence.

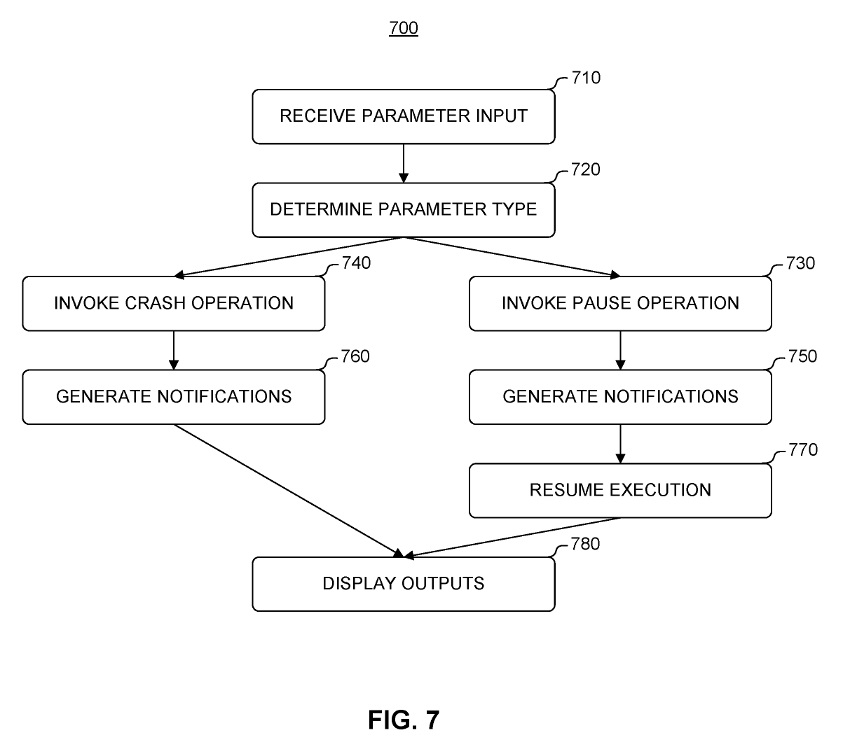

Turning to FIG. 7, a method 700 is shown of an exemplary method for software testing, consistent with disclosed embodiments. The method 700 may begin at step 710, where the system may receive a parameter input. The parameter may be supplied by a developer or tester through any suitable interface, such as a command line input, a configuration file, a graphical user interface, or an API call. The parameter may take multiple forms, including a numerical value (e.g., representing a period of time in milliseconds or seconds), a string (e.g., a keyword such as “crash” or “pause”), a null value (indicating that no action should be taken or that an error condition is to be simulated), or a composite value containing multiple fields. In some embodiments, parameters may be transmitted from a user device, retrieved from memory, or automatically generated by a test script or CI/CD pipeline.

The reception of the parameter may differ depending on the programming language of the application under test. For example, the parameter may be added when the program is being prepared or packaged. Alternatively, the parameter can be provided while the program is running. In either case, the testing tool may apply the parameter in a consistent way so that the behavior of the software element can be observed

At step 720, the method 700 may include determining the parameter type. This step may allow the system to correctly interpret whether the parameter directs the tool to pause execution, crash the software, or perform another operation. In some embodiments, the parameter determination may be performed by a processor executing instructions stored on a computer-readable medium, such as RAM, ROM, flash storage, or another hardware memory device. The determination process may involve parsing the parameter, validating its format, and comparing it to a set of known values or rules. For example, a parameter of “sleep=5000” may be classified as a pause instruction, whereas a parameter of “throwException” may be classified as a crash instruction. By standardizing this classification, the system may consistently interpret the parameter across different test runs, languages, or environments.

If the parameter type is identified as a pause instruction, the method proceeds to step 730, which may include invoking a pause operation in the software under test. The pause may be implemented using a thread sleep command, timer, or other scheduling instruction that halts execution for a defined period of time. The length of the pause may be specified by the numerical value provided in the parameter, such as 10 seconds, or may default to a predetermined interval. During the pause, the system may continue to monitor for external conditions, such as interrupt signals or dependency events.

At step 750, the system may generate notifications indicating that the pause was invoked, its intended duration, whether the pause was completed successfully, and whether an interrupt routine caused the pause to terminate early. These notifications may be logged in a file, output to a console, or transmitted to an external monitoring service.

Alternatively, if the parameter type is identified as a crash instruction, the method may proceed to step 740, which may include invoking a crash operation. The crash may be simulated by deliberately throwing an exception, halting a process, corrupting a variable, or otherwise forcing an execution error in the software element. This allows the tester to observe how the application responds to unexpected termination events. At step 760, the system may generate notifications related to the crash, including an indication that a crash occurred, the time of occurrence, the specific process or thread affected, and whether the crash was intended as part of testing. In some embodiments, the notification may further indicate whether the crash triggered built-in recovery mechanisms or whether the system failed to respond as expected.

After the pause operation concludes, the method may proceed to step 770, which may include resuming execution of the software element under test. Resumption may involve restoring a suspended thread, continuing to process queued instructions, or reestablishing lost connections to external services. In some embodiments, resumption may occur automatically after the completion of a pause, while in other embodiments resumption may require explicit input from the tester. Where a crash has been simulated, resumption may involve restarting the affected software element, recovering system state from memory, or invoking a fallback process. This may demonstrate that the application can continue to function or at least provide meaningful failure states that testers can evaluate.

Finally, at step 780, the method may include displaying outputs derived from the notifications generated in steps 750 and 760. These outputs may be provided on a user device, such as a developer’s workstation, a laptop, a tablet, or another computing platform. In some embodiments, the outputs may include raw log files or console messages. In other embodiments, the outputs may take the form of unique visualizations, such as dashboards, charts, or execution timelines that show the order of operations and timing of events. The visualization may highlight when a pause occurred, when an interrupt was detected, when a crash was invoked, and when resumption took place, thereby enabling the tester to confirm the correctness of software behavior under test. In further embodiments, the outputs may be formatted in compliance with regulatory or organizational standards, ensuring that test results can be audited or reviewed as part of a compliance workflow.

FIG. 7 therefore illustrates how a parameter-driven testing workflow may be carried out in a consistent, repeatable manner. By enabling testers to specify inputs, classify parameters, invoke controlled pauses or crashes, resume execution, and observe detailed outputs, the disclosed method provides a structured and reliable approach to evaluating the execution characteristics of software elements. This flowchart complements the system overview of FIG. 6 and demonstrates how the individual components of the software testing tool may be applied to a method of operation.

In some embodiments, use of the software testing tool may require the inclusion of supporting code within the software being tested, as explained above. The supporting code may permit invocation of the software testing tool through one or more software elements that are executed during operation of the software. In some embodiments, use of the software testing tool may further require the inclusion of at least one software element in the software being tested to invoke the software testing tool. The at least one software element may include a software testing tool parameter, which in turn directs the behavior of the testing tool.

In some embodiments, invocation of the software testing tool may require the inclusion of a value associated with the software testing tool parameter with a software execution request. The parameter value may take different forms depending on the desired behavior. For example, in some embodiments, the value associated with the software testing tool parameter may be a numerical value, which may correspond to a period of time for which the software being tested should pause or sleep at the location corresponding to the software testing tool parameter. The numerical value may be in seconds, milliseconds, microseconds, clock cycles, and/or other unit of time. Such values allow control of software execution timing and enable the software testing tool to deliberately introduce concurrency conditions or race states.

In some embodiments, the value associated with the software testing tool parameter may be a string. A string value may include a crash instruction, such as a token indicating that the software being tested should crash at the location corresponding to the software testing tool parameter. A string value may also correspond to other forms of functional behavior, such as logging or messaging, thereby allowing the tester to direct how the testing tool interacts with the execution flow of the software element. By allowing parameters to be expressed as strings, the software testing tool provides a flexible mechanism for stimulating different types of failures or disruptions.

In some embodiments, no value may be associated with the software testing tool parameter. In some such embodiments, the value may be treated as null. In some such embodiments, the absence of a value associated with the software testing tool parameter may cause an execution error by the software testing tool, thereby permitting validation of error handling behavior. In some embodiments, a null value should be included in the value associated with the software testing tool parameter. In some embodiments, the value may be automatically or manually included within or placed into the software to be tested, enabling developers to assess how software responds to incomplete or invalid configuration values.

Some embodiments of the present disclosure may allow the software testing tool to be invoked by duplicate concurrent executions of the same software or same functionality using the same resource. In such embodiments, use of the software testing tool may allow a software tester to confirm that execution of one instance of software does or does not interfere with the execution of another instance of the software. For example, during execution of a payment clearing operation, it may be desirable that a first instance of software execution prevent duplicate instances of software execution, to prevent the system from clearing the same payment multiple times. In such instances, a software tester may invoke the software testing tool to determine whether the first instance of a payment clearing operation properly prevents the operation of a second instance from proceeding at the same point in time.

The use of a software testing tool according to the present disclosure may permit the software tester to simulate situations whether multiple instances attempt to perform the same or related function. By invoking this tool, the tester may execute the two instances at favorable points in time to test the ability of the first instance to prevent the operation of the second instance at the favorable points in time. One or more invocations of a software testing tool according to the present disclosure may facilitate such tests, which may have been prohibitively difficult to test in a deployed testing environment (as opposed to locally) using existing testing tools. This type of testing may be particularly useful in systems where concurrency is inherent, such as financial transaction processing, database operations, or distributed services.

In some embodiments, multiple invocations of the testing tool may be used to stagger or offset execution of duplicate instances in order to identify potential race conditions or other undesirable interactions. Without such a tool, testing these concurrency scenarios may be prohibitively complex or resource intensive.

In some embodiments, the disclosed testing tool may be applied to applications where multiple requests or operations are executed at the same time. There is a risk that duplicate requests could lead to duplicate results if the system only checks for duplicates once at the beginning of execution. By placing parameters at specific points in the process, a developer may test whether the system responds correctly when duplicate or near-simultaneous requests are introduced.

For example, a parameter may be placed before a check is performed, such that the tool causes a pause or delay in order to simulate timing differences between requests. By controlling this timing, the tool may allow the developer to confirm whether the system continues to enforce the duplicate check under varied conditions. Similarly, parameters may be used to slow down or interrupt later steps in the process, so that the effect of concurrent execution can be observed at multiple stages.

Through this type of parameter placement, the disclosed tool provides a controlled and repeatable way to simulate concurrent or duplicate execution, without requiring the developer to manually recreate timing variations. This enables more reliable testing of edge cases where small changes in timing could otherwise lead to unexpected results.

In some embodiments, the disclosed software testing tool may be stored within one or more forms of memory associated with a computing device. Such memory may include both transitory and non-transitory forms, allowing the tool to be retrieved and executed as needed. The memory may store the testing tool in a format suitable for repeated use, so that the tool may be invoked during multiple test sessions without requiring reinstallation. In certain embodiments, the memory may also include the configuration of parameters that a developer intends to use for a given test, thereby allowing the testing environment to be restored or reproduced at a later time, to increase ease of integration.

Examples of memory suitable for storing the testing tool may include read-only memory (ROM), random access memory (RAM), or hardware-based storage such as solid-state drives, magnetic drives, or server-based repositories. In some embodiments, optical media or other machine-readable formats may be employed. These examples illustrate that the disclosed tool is not limited to a particular storage medium but may instead be adapted for storage in a wide variety of computing environments. By providing this flexibility, the tool may be stored and accessed in a way that is compatible with the specific infrastructure of the system under test.

In operation, a processor associated with the computing system may retrieve instructions corresponding to the testing tool from the memory and carry out one or more operations directed by a tester. The processor may execute such instructions sequentially or concurrently, depending on how the parameters are configured. In this manner, the processor, memory, and testing tool may function cooperatively to alter the execution characteristics of the software element under test. The use of memory to store the tool and the processor to execute it ensures that the disclosed embodiments can be implemented using conventional computing hardware, while still providing enhanced control over the testing process.

In some embodiments, the disclosed system may be configured to test cases in milliseconds, enabling rapid iteration and repeatability. Such speed allows testers to run multiple scenarios in quick succession, ensuring that timing sensitive behaviours can be evaluated without delay.

In some embodiments, the execution of the software testing tool according to the present disclosure may involve execution by a processor of instructions stored on a non-transitory computer readable medium that, when executed by the processor, cause the processor to perform one or more steps of the disclosed methods. This ensures that the software testing tool can be embodied in a physical medium suitable for distribution, storage, and later execution within a testing environment.

The disclosed embodiments are not limited to the above-described examples but instead are defined by the appended claims in light of their full scope of equivalents. Moreover, while illustrative embodiments have been described herein, the scope includes any and all embodiments having equivalent elements, modifications, omissions, combinations (e.g., of aspects across various embodiments), adaptations, or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods may be modified in any manner, including by reordering steps or inserting or deleting steps.

It is intended, therefore, that the specification and examples be considered as examples only, with a true scope and spirit being indicated by the following claims and their full scope of equivalents.

What is claimed is:

1. A computer readable medium storing instructions that when executed by one or more processors cause the one or more processors to perform operations comprising:
receive a parameter configured to affect execution of a software element;
determine whether the parameter contains a numerical value corresponding to a period of time;
responsive to the determination:
pause execution of the software element for a duration corresponding to the period of time;
send a first notification to a user device associated with the software element advising that the software element is paused for the duration;
permit resumption of execution of the software element following the duration; and
send a second notification to the user device advising that execution of the software element has resumed following the duration.

2. The computer readable medium of claim 1, wherein the pause includes issuing a thread sleep instruction to a thread executing the software element.

3. The computer readable medium of claim 1, the operations further comprising:
detect an interrupt signal during the pause; and
terminate the pause in response to the interrupt signal.

4. The computer readable medium of claim 1, wherein the numerical value is in milliseconds.

5. The computer readable medium of claim 1, wherein the first and second notifications are logged to a log file.

6. The computer readable medium of claim 1, the operations further comprising: send a third notification to the user device advising that: the value is received, the software being tested is sleeping for a period of time corresponding to the value, that sleep was interrupted, or the period of sleep corresponding to the value has concluded.

7. A method comprising:
receiving a parameter configured to affect execution of a software element;
determining whether the parameter contains a numerical value corresponding to a period of time;
responsive to the determination:
pausing execution of the software element for a duration corresponding to the period of time;
sending a first notification to a user device associated with the software element advising that the software element is paused for the duration;
permitting resumption of execution of the software element following the duration; and
sending a second notification to the user device advising that execution of the software element has resumed following the duration.

8. The method of claim 7, wherein the pause includes issuing a thread sleep instruction to a thread executing the software element.

9. The method of claim 7, further comprising:
detecting an interrupt signal during the pause; and
terminating the pause in response to the interrupt signal.

10. The method of claim 7, wherein the numerical value is in milliseconds.

11. The method of claim 7, wherein the first and second notifications are logged to a log file.

12. The method of claim 7, further comprising: sending a third notification to the user device advising that: the value is received, the software being tested is sleeping for a period of time corresponding to the value, that sleep was interrupted, or the period of sleep corresponding to the value has concluded.

13. A system comprising:
a processor; and
a memory storing a set of software instructions that, when executed by the processor, cause the processor to perform operations including:
receive a parameter configured to affect execution of a software element;
determine whether the parameter contains a numerical value corresponding to a period of time;
responsive to the determination:
pause execution of the software element for a duration corresponding to the period of time;
send a first notification to a user device associated with the software element advising that the software element is paused for the duration;
permit resumption of execution of the software element following the duration; and
send a second notification to the user device advising that execution of the software element has resumed following the duration.

14. The system of claim 13, wherein the pause includes issuing a thread sleep instruction to a thread executing the software element.

15. The system of claim 13, the operations further including:
detect an interrupt signal during the pause; and
terminate the pause in response to the interrupt signal.

16. The system of claim 13, wherein the numerical value is in milliseconds.

17. The system of claim 13, wherein the first and second notifications are logged to a log file.

18. The system of claim 13, the operations further including: send a third notification to the user device advising that: the value is received, the software being tested is sleeping for a period of time corresponding to the value, that sleep was interrupted, or the period of sleep corresponding to the value has concluded.

19. A computer readable medium storing instructions that when executed by one or more processors cause the one or more processors to perform operations comprising:
receive a parameter configured to affect execution of a software element;
determine whether the parameter contains an instruction associated with the software element; and
responsive to the determination:
execute a crash of the software element; and
send a notification to a user device associated with the software element advising that the software element crashed.

20. The computer readable medium of claim 19, the operations further comprising:
send an exception associated with the execution crash.

21. The computer readable medium of claim 19, wherein the crash occurs at a user-defined location within the software element.

22. The computer readable medium of claim 19, wherein the parameter is a numerical value, a string, or no value.

23. The computer readable medium of claim 22, wherein the numerical value is a unit of time.

24. The computer readable medium of claim 19, wherein the notification is logged to a log file.

25. A method comprising:
receive a parameter configured to affect execution of a software element;
determine whether the parameter contains an instruction associated with the software element; and
responsive to the determination:
execute a crash of the software element; and
send a notification to a user device associated with the software element advising that the software element crashed.

26. The method of claim 25, further comprising:
sending an exception associated with the execution crash.

27. The method of claim 25, wherein the crash occurs at a user-defined location within the software element.

28. The method of claim 25, wherein the parameter is a numerical value, a string, or no value.

29. The method of claim 28, wherein the numerical value is a unit of time.

30. The method of claim 25, wherein the notification is logged to a log file.

31. A system comprising:
a processor; and
a memory storing a set of software instructions that, when executed by the processor, cause the processor to perform operations including:
receive a parameter configured to affect execution of a software element;
determine whether the parameter contains an instruction associated with the software element; and
responsive to the determination:
execute a crash of the software element; and
send a notification to a user device associated with the software element advising that the software element crashed.

32. The system of claim 31, the operations further including:
send an exception associated with the execution crash.

33. The system of claim 31, wherein the crash occurs at a user-defined location within the software element.

34. The system of claim 31, wherein the parameter is a numerical value, a string, or no value.

35. The system of claim 34, wherein the numerical value is a unit of time.

36. The system of claim 31, wherein the notification is logged to a log file.
